(19) United States
(12) Patent Application Publication
(10) Pub. No.: US 2002/0071276 A1
(43) Pub. Date: Jun. 13, 2002

(54) Flexible shape-retaining lighting device

(76) Inventor: Ariana L. Blum, Jersey City, NJ (US)

Correspondence Address: Blum, Ariana L., 255 Warren Street # 910, Jersey City, NJ, 07302, US

(21) Appl. No.: 09/735,720

(22) Filed: Dec. 12, 2000

(51) Int. Cl. F21V 21/32; F21V 17/02

(52) U.S. Cl. 362/250; 362/235; 362/278; 362/320

(57) ABSTRACT

A lighting device having a selectably changeable shape. Such lighting device includes a flexible lighting element and an adjustable shape-retaining element coupled to the flexible lighting element which can be mounted in a transparent or translucent flexible covering.

According to a preferred embodiment of the invention, the flexible lighting element is mounted in a flexible covering including the adjustable shape-retaining element. Preferably, the flexible covering is transparent or translucent.

According to one embodiment of the invention, the flexible lighting element includes a rope light.

According to another embodiment, the adjustable shape-retaining element is a metal wire.

According to another embodiment of the invention, the adjustable shape-retaining element includes shapeable wires incorporated in at least part of the flexible covering.

There is also provided a method for providing a shapeable lighting device, the method including coupling an adjustable shape-retaining element to a flexible lighting element.

According to one embodiment of the invention, the method further includes mounting the flexible lighting element in a transparent or translucent flexible covering.

According to another embodiment of the invention, the step of coupling includes providing an adjustable shape-retaining element in the flexible covering.

### FIELD OF THE INVENTION

The present invention relates to lighting devices in general and, in particular, to a flexible shape-retaining lighting device incorporating a rope light.

### BACKGROUND OF THE INVENTION

Conventional lighting devices include a light bulb of a relatively rigid pre-selected shape, which first end fits into a light bulb socket and which second end fits in a shade or cover of sorts. Due to the fixed size and shape of the light bulb, it is very difficult, if not impossible, for the user to change the shape of conventional lighting devices.

It has long been desired to decorate a variety of objects with strings of lights. Generally, this is accomplished by a plurality of light bulbs connected in parallel between two long wires, and the wires are strung or hung about the object to be decorated. These strings of light suffer from the disadvantage that they are relatively large in size and thus cannot be used to decorate small objects, and cannot be shaped at the will of the user without being strung to the object to be decorated or hung about it.

A figure light, formed of a plurality of bulb sockets fastened between two rails in a figured support, is shown in U.S. Pat. No. 5,993,025 to Huang. This lighting device permits the creation of a figured support of any pre-selected shape into which the light bulbs can be fastened.

Recently, so-called rope lights became popular, such as those described in U.S. Pat. No. 4,812,956 to Chen. These include a plurality of small bulbs, possibly of different colors, molded in a plastic rope. Such rope lights have been used to decorate a number of different types of items, by affixing the rope light to a frame in a desired shape. A few examples include illuminating the ring of a basketball hoop, in U.S. Pat. No. 5,833,558 to Pettle, and illuminating the ribs in an umbrella, in U.S. Pat. No. 5,911,493 to Walker et al.

None of these lighting devices permit a user to change at his or her will the shape of the lighting device, and to retain that shape without affixing light bulbs to a pre-selected shaped or figured support.

### SUMMARY OF THE INVENTION

According to the present invention, there is provided a lighting device having a selectably changeable shape.

According to one embodiment of the invention, the lighting device includes a flexible lighting element and an adjustable shape-retaining element coupled to the flexible lighting element.

According to a preferred embodiment, the lighting device includes a flexible lighting element mounted in a flexible covering, the flexible covering including an adjustable shape-retaining element. Preferably, the flexible covering is transparent or translucent.

According to one embodiment of the invention, the flexible lighting element includes a rope light.

According to another embodiment, the adjustable shape-retaining element is a metal wire.

According to another embodiment of the invention, the adjustable shape-retaining element includes shapeable wires incorporated in at least part of the flexible covering.

There is also provided a method for providing a shapeable lighting device, the method including coupling an adjustable shape-retaining element to a flexible lighting element.

According to one embodiment of the invention, the method further includes mounting the flexible lighting element in a transparent or translucent flexible covering.

According to another embodiment of the invention, the step of coupling includes providing an adjustable shape-retaining element in the flexible covering.

### BRIEF DESCRIPTION OF THE DRAWINGS

The present invention will be further understood and appreciated from the following detailed description taken in conjunction with the drawings in which:

FIG. 1 is a schematic illustration of a lighting device constructed and operative in accordance with one embodiment of the present invention;

FIG. 2a is a side view of a section of the lighting device of FIG. 1 in accordance with one embodiment of the present invention;

FIG. 2b is a side view of a section of the lighting device of FIG. 1 in accordance with another embodiment of the present invention;

FIG. 3 is a partially cut away plan view of a lighting device constructed and operative in accordance with another embodiment of the present invention; and

FIG. 4 is a cross-sectional view of the lighting device of FIG. 3.

### DETAILED DESCRIPTION OF THE INVENTION

The present invention relates in general to flexible lighting devices in which the illuminated portion is flexible and its shape can be selectably changed and retained, as desired. In particular, the flexible lighting device includes a flexible lighting element to which an adjustable shape-retaining element is coupled.

According to one embodiment of the invention, the adjustable shape-retaining element is integrally formed with the flexible lighting element.

According to another embodiment, the flexible lighting element is mounted in a flexible covering. Preferably, the flexible covering is transparent or translucent. In this embodiment, the adjustable shape-retaining element can be coupled directly to the flexible lighting element, or inserted or sewn or otherwise mounted in the flexible covering.

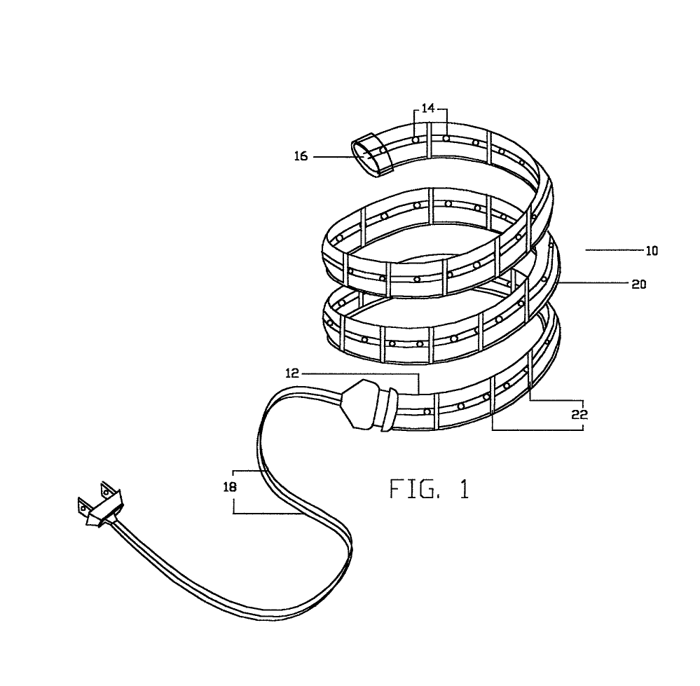

Referring now to FIG. 1, there is shown a lighting device 10 constructed and operative in accordance with one embodiment of the present invention. lighting device 10 includes a transparent or translucent flexible lighting element 12, here illustrated as a rope light. Flexible lighting element 12 includes a plurality of tiny light bulbs 14 molded in a plastic tube 16 coupled by a pair of wires 18, as known.

According to the present invention, an adjustable shape-retaining element 20 is coupled to the flexible lighting element. This permits the shape of the flexible lighting element to be changed, and the new shape to be retained without being affixed to a stable support frame, which is not possible with prior art rope light.

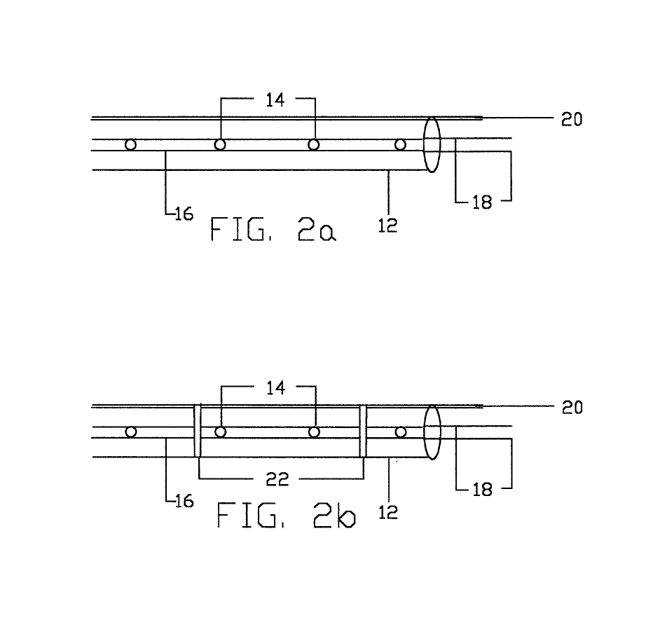

According to one embodiment of the invention, illustrated in FIG. 2a, which is a side view of a section of the lighting device of FIG. 1, the adjustable shape-retaining element is a metal wire which is molded into the plastic tube 16, so as to form an integral part of the flexible lighting element.

According to an alternative embodiment of the present invention illustrated in FIG. 2b, which is a side view of the lighting device of FIG. 1, the adjustable shape-retaining element 20 is a metal wire which is coupled along or around the flexible lighting element 12 by fastening means 22.

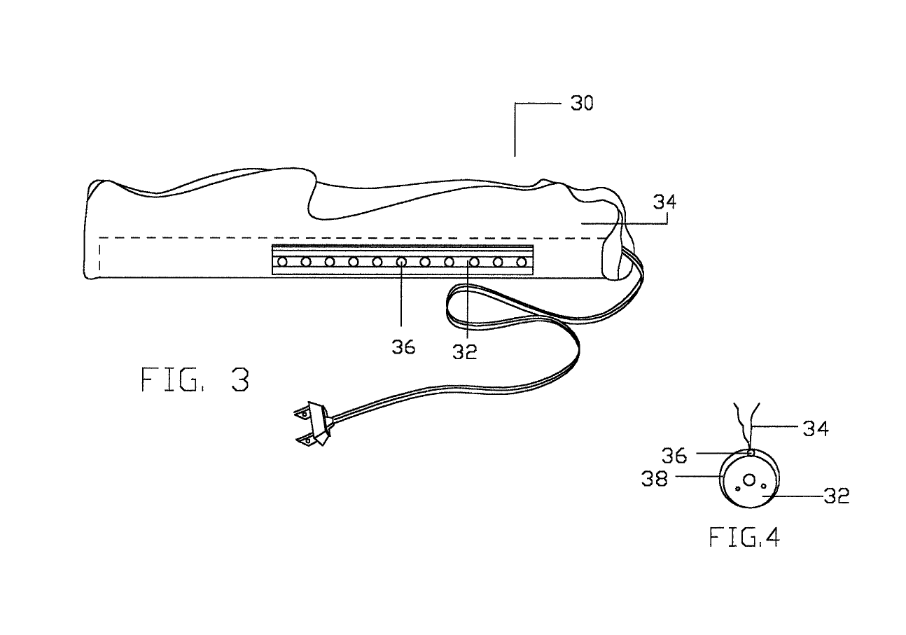

FIG. 3 is a partially cut away plan view of a lighting device 30 constructed and operative in accordance with another embodiment of the present invention. In this embodiment, a flexible lighting element 32 is mounted in a flexible covering 34. It will be appreciated that flexible covering 34 is transparent or translucent, so as to permit the light from the tiny bulbs molded in the flexible lighting element to be seen therethrough. As known with conventional rope lights, the flexible lighting element is designed so as to output a minimum of heat. Flexible covering 34 can be formed of any suitable material including, but not limited to, fabric, plastic, and paper.

Flexible covering 34 of this embodiment includes an adjustable shape-retaining element 36 incorporated therein. As seen in FIG. 4, a cross-sectional view of the lighting device of FIG. 3, the flexible lighting element 32 is inserted in a narrow sleeve 38 in the flexible covering, and an adjustable shape-retaining element 36, in the form of an elongate wire or strip, which can be bent or curved and retains the bent or curved shape, extends coaxially through the sleeve 38. Alternatively, the shape-retaining element 36 can be coupled directly to the flexible lighting element, as described above, or can be sewn, woven, or otherwise incorporated into the flexible covering.

It will be appreciated that the invention is not limited to what has been described hereinabove merely by way of example. Rather, the invention is limited solely by the claims which follow.

What is claimed is:

1. A lighting device having a selectably changeable shape.

2. The lighting device according to claim 1, comprising:
a flexible lighting element; and
an adjustable shape-retaining element coupled to said flexible lighting element.

3. The lighting device according to claim 2, wherein said adjustable shape-retaining element is integrally formed with said flexible lighting element.

4. The lighting device according to claim 3, wherein:
said flexible lighting element includes a plurality of tiny light bulbs molded in a plastic tube; and
said adjustable shape-retaining element is molded in said plastic tube.

5. The lighting device according to claim 1, further comprising:
a translucent flexible covering coupled about said flexible lighting element.

6. The lighting device according to claim 5, wherein said flexible covering is transparent.

7. The lighting device according to claim 1, comprising a flexible lighting element mounted in a translucent, flexible covering, said flexible covering including an adjustable shape-retaining element.

8. The lighting device according to claim 7, wherein said flexible covering is transparent.

9. The lighting device according to claim 2, wherein said flexible lighting element includes a rope light.

10. The lighting device according to claim 2, wherein said adjustable shape-retaining element is a metal wire.

11. The lighting device according to claim 7, wherein said adjustable shape-retaining element includes shapeable wires incorporated in at least part of said flexible covering.

12. A method for providing a selectably changeable shape lighting device, the method comprising coupling an adjustable shape-retaining element to a flexible lighting element.

13. The method according to claim 12, wherein said step of coupling includes integrally forming said adjustable shape-retaining element with said flexible lighting element.

14. The method according to claim 12, further comprising: mounting the flexible lighting element in a translucent flexible covering.

15. The method according to claim 13, further comprising: mounting the flexible lighting element in a translucent flexible covering.

16. The method according to claim 14, wherein said flexible covering is transparent.

17. The method according to claim 15, wherein said flexible covering is transparent.

18. The method according to claim 14, wherein the step of coupling includes incorporating an adjustable shape-retaining element in the flexible covering.

19. The method according to claim 15, wherein the step of coupling includes incorporating an adjustable shape-retaining element in the flexible covering.
